(19) United States
(12) Patent Application Publication
(10) Pub. No.: US 2024/0385872 A1
(43) Pub. Date: Nov. 21, 2024

(54) Aggregation and Scheduling of Accelerator Executable Tasks

(71) Applicant: Advanced Micro Devices, Inc., Santa Clara, CA (US)

(72) Inventors: Martha Massee Barker, Seattle, WA (US); Anthony Thomas Gutierrez, Seattle, WA (US); Mark Unruh Wyse, Seattle, WA (US); Ali Arda Eker, Bellevue, WA (US)

(73) Assignee: Advanced Micro Devices, Inc., Santa Clara, CA (US)

(21) Appl. No.: 18/198,981

(22) Filed: May 18, 2023

(51) Int. Cl. G06F 9/48

(52) U.S. Cl. CPC G06F 9/4843

(57) ABSTRACT

In accordance with the described techniques for aggregation and scheduling of accelerator executable tasks, an accelerator device includes a processing element array and a command processor to receive a plurality of fibers each including multiple tasks and dependencies between the multiple tasks. The command processor places a first fiber in a sleep pool based on a first task within the first fiber having an unresolved dependency, and the command processor further places a second fiber in a ready pool based on a second task within the second fiber having a resolved dependency. Based on the second fiber being in the ready pool, the command processor launches the second task to be executed by the processing element array.

### BACKGROUND

In multicore and heterogeneous systems, parallel processing improves computer performance by dividing a computer program into fine-grained tasks that are executable simultaneously. These computer programs are typically represented as a task graph that includes processing tasks and dependencies between the processing tasks. Scheduling logic is implemented in these systems to preserve the dependencies between the tasks. However, conventional task scheduling logic often stalls tasks that are ready for dispatch, which leads to resource underutilization and decreased in-parallel execution of tasks.

### BRIEF DESCRIPTION OF THE DRAWINGS

FIG. 1 is a block diagram of a non-limiting example system to implement task aggregation and scheduling techniques.

FIG. 2 depicts a non-limiting example in which a compiler partitions a task graph into fibers.

FIG. 3 depicts a non-limiting example having a fiber and a set of operations for launching tasks within the fiber.

FIG. 4 depicts a non-limiting example having a fiber and a set of operations for launching tasks within the fiber.

FIG. 5 depicts a non-limiting example having a fiber and a set of operations for launching tasks within the fiber.

FIG. 6 depicts a procedure in an example implementation of aggregation and scheduling of accelerator executable tasks.

### DETAILED DESCRIPTION

### Overview

A system includes a host having a compiler communicatively coupled to an accelerator device having a command processor and a processing element array. The host receives a program that is represented by a task graph, which includes a plurality of tasks and dependencies between the tasks. Generally, the system is configured to preserve the dependencies while maximizing in-parallel execution of the tasks by the processing element array. To do so, the system implements scheduling logic to schedule the tasks. Conventional task scheduling techniques implement scheduling logic in the host to statically schedule tasks to a task queue of an accelerator device. To enforce dependencies, these conventional techniques insert barriers between individual tasks which instruct the accelerator device to stall dispatching tasks from the task queue until an in-flight task has finished executing. This results in head-of-line blocking for the task queue because tasks that are deeper in the task queue than a barrier are prevented from being dispatched, even if the tasks have no unresolved dependencies.

In accordance with the described techniques, the compiler receives the task graph and generates a fiber graph from the task graph. The fiber graph includes a plurality of fibers that each include multiple tasks and dependencies between the multiple tasks. Moreover, the fiber graph includes dependencies between the plurality of fibers. In addition to generating the fibers, the compiler defines operations for each of the fibers that instruct the command processor when to launch individual tasks within respective fibers to be executed by the processing element array.

In particular, the command processor includes a scheduler that maintains a sleep pool and a ready pool. The operations for a respective fiber instruct the scheduler to move a respective fiber between the sleep pool and the ready pool based on whether the respective fiber has unresolved dependencies. For example, the operations instruct the scheduler to place the respective fiber in the sleep pool based on all unexecuted tasks in the respective fiber having an unresolved dependency. In accordance with the described techniques, a task has an unresolved dependency if an additional task on which the task depends has not been executed. In addition, the operations instruct the scheduler to place the respective fiber in the ready pool based on the dependencies of at least one task in the fiber being resolved. In one or more implementations, a task has a resolved dependency when an additional task on which the task depends has been executed. In accordance with the described techniques, the command processor moves tasks (e.g., tasks that have resolved dependencies) from fibers that are in the ready pool to the task queue of the accelerator device. From the task queue, the command processor dispatches tasks for execution by the processing element array. In contrast, the command processor does not move tasks from fibers that are in the sleep pool to the task queue.

Accordingly, the command processor solely moves tasks that are ready to be dispatched to the task queue. Thus, in contrast to conventional techniques, the described techniques enable tasks to be dispatched from the task queue without stalling. Further, in one or more implementations, the scheduler concurrently moves multiple independent fibers between the sleep pool and the ready pool. By doing so, the command processor launches tasks from fibers that are in the ready pool, while one or more fibers that are in the sleep pool wait for dependencies to be resolved. This contrasts with conventional techniques which stall dispatching tasks while waiting for a dependency to be resolved. Therefore, the described techniques enable more tasks to be in-flight simultaneously, thereby increasing parallelism for executing the tasks and increasing overall computer performance.

Moreover, the described techniques utilize a hybrid scheduling technique in which both dynamic scheduling and static scheduling are utilized to schedule the tasks. Indeed, the individual tasks within each fiber are statically scheduled by the compiler, while the dependencies between the fibers are enforced dynamically by the command processor and/or scheduler. By partitioning the task graph into the fibers, the compiler coarsens the task graph, thereby creating fewer schedulable entities. Indeed, conventional host-based scheduling logic schedules each individual task to the task queue of the accelerator device, whereas the described scheduler solely schedules the fibers. Therefore, the described techniques decrease scheduler overhead, which also improves overall computer performance.

In some aspects, the techniques described herein relate to an accelerator device, comprising a processing element array, and a command processor to receive a plurality of fibers each including multiple tasks and dependencies between the multiple tasks, place a first fiber in a sleep pool based on a first task within the first fiber having an unresolved dependency, place a second fiber in a ready pool based on a second task within the second fiber having a resolved dependency, and launch the second task to be executed by the processing element array based on the second fiber being in the ready pool.

In some aspects, the techniques described herein relate to an accelerator device, wherein the first task is dependent on an additional task within the first fiber, and the unresolved dependency is based on the additional task having been launched by the command processor but unexecuted by the processing element array.

In some aspects, the techniques described herein relate to an accelerator device, wherein the second task is dependent on an additional task within the second fiber, and the resolved dependency is based on the additional task having been launched by the command processor and subsequently executed by the processing element array.

In some aspects, the techniques described herein relate to an accelerator device, wherein the command processor is configured to maintain a count of remaining unexecuted tasks in the second fiber, set a wait parameter indicating a value of the count that represents the resolved dependency, receive a completion signal from the processing element array indicating that the additional task has been executed, reduce the count in response to the completion signal being received, and place the second fiber in the ready pool based on the reduced count being equal to the value indicated by the wait parameter.

In some aspects, the techniques described herein relate to an accelerator device, wherein the command processor is configured to reduce the count in order of task execution, the count being reduced based on the completion signal despite a previously launched command of the second fiber being unexecuted.

In some aspects, the techniques described herein relate to an accelerator device, wherein the command processor is configured to reduce the count in order of task launch, the command processor stalling reduction of the count based on the completion signal until an additional completion signal is received indicating that a previously launched command of the second fiber has been executed.

In some aspects, the techniques described herein relate to an accelerator device, wherein the plurality of fibers indicate fiber level dependencies between the plurality of fibers, and wherein the command processor is configured to stall launch of tasks from a dependent fiber until the multiple tasks of an additional fiber on which the dependent fiber depends are executed by the processing element array.

In some aspects, the techniques described herein relate to an accelerator device, wherein the plurality of fibers include multiple independent fibers, and wherein the command processor is configured to dispatch at least one task from each of the multiple independent fibers for in parallel execution by the processing element array.

In some aspects, the techniques described herein relate to a computing device, comprising an accelerator device that includes a command processor and a processing element array, and a host that includes a compiler, the compiler configured to receive a task graph that includes a plurality of tasks and indicates dependencies between the plurality of tasks, generate a fiber graph by partitioning the task graph into multiple fibers, the multiple fibers including, respectively, multiple tasks of a different portion of the task graph, and define operations for the multiple fibers, the operations instructing the command processor to move the multiple fibers from a sleep pool to a ready pool based on the dependencies of the multiple fibers being resolved, tasks from fibers that are in the ready pool being launched by the command processor to be executed by the processing element array.

In some aspects, the techniques described herein relate to a computing device, wherein the operations are defined by the compiler in an intermediate representation.

In some aspects, the techniques described herein relate to a computing device, wherein a respective fiber includes a first task and a second task that is dependent on the first task, and the operations for the respective fiber instruct the command processor to launch the first task to be executed by the processing element array, place the respective fiber in the sleep pool based on the first task being launched, and move the respective fiber to the ready pool based on the first task having been executed by the processing element array.

In some aspects, the techniques described herein relate to a computing device, wherein the fiber graph indicates fiber level dependencies between the multiple fibers, the fiber level dependencies directing the command processor to stall launch of tasks from a dependent fiber until the multiple tasks of an additional fiber on which the dependent fiber depends are executed by the processing element array.

In some aspects, the techniques described herein relate to a computing device, wherein the fiber graph indicates multiple independent fibers, the multiple independent fibers directing the command processor to dispatch at least one task from each of the multiple independent fibers for in parallel execution by the processing element array.

In some aspects, the techniques described herein relate to a computing device, wherein the task graph is a directed acyclic graph, and the multiple fibers are acyclic.

In some aspects, the techniques described herein relate to a method, comprising receiving, by a command processor of an accelerator device, a fiber that includes multiple tasks and dependencies between the multiple tasks, generating, by the command processor, multiple sub-fibers from the fiber, the multiple sub-fibers each including two or more tasks that are independent of tasks within other sub-fibers, placing, by the command processor, a first sub-fiber in a sleep pool based on a first task within the first sub-fiber having an unresolved dependency, placing, by the command processor, a second sub-fiber in a ready pool based on a second task within the second sub-fiber having a resolved dependency, and launching, by the command processor, the second task to be executed by a processing element array of the accelerator device based on the second sub-fiber being in the ready pool.

In some aspects, the techniques described herein relate to a method, further comprising moving, by the command processor, the first sub-fiber to the ready pool based on the unresolved dependency being resolved, and launching, by the command processor, the first task to be executed by the processing element array in parallel with the second task.

In some aspects, the techniques described herein relate to a method, wherein the first task is dependent on an additional task within the first sub-fiber, and the unresolved dependency is based on the additional task having been launched by the command processor but unexecuted by the processing element array.

In some aspects, the techniques described herein relate to a method, wherein the second task is dependent on an additional task within the second sub-fiber, and the resolved dependency is based on the additional task having been launched by the command processor and subsequently executed by the processing element array.

In some aspects, the techniques described herein relate to a method, further comprising maintaining, by the command processor, a count of remaining unexecuted tasks in the first sub-fiber, setting, by the command processor, a wait parameter indicating a value of the count that represents the unresolved dependency being resolved, and placing, by the command processor, the first sub-fiber in the sleep pool based on the count being unequal to the value.

In some aspects, the techniques described herein relate to a method, further comprising maintaining, by the command processor, a count of remaining unexecuted tasks in the second sub-fiber, setting, by the command processor, a wait parameter indicating a value of the count that represents the resolved dependency, and placing, by the command processor, the second sub-fiber in the ready pool based on the count being equal to the value.

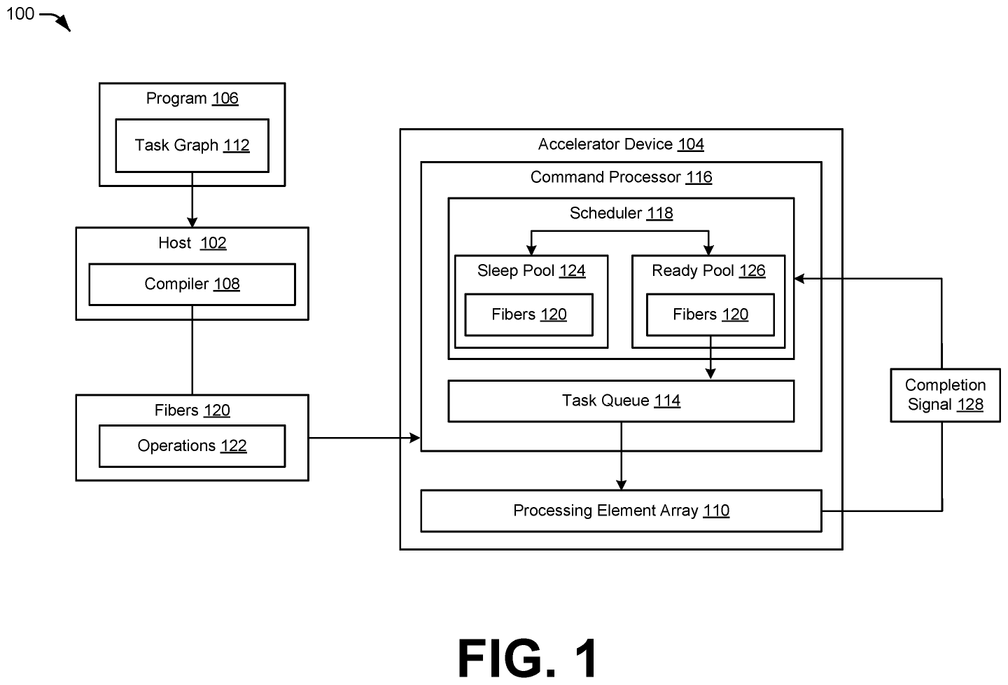

FIG. 1 is a block diagram of a non-limiting example system 100 to implement task aggregation and scheduling techniques. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

In accordance with the described techniques, the system includes a host 102 and an accelerator device 104, which are coupled to one another via a wired or wireless connection. Example wired connections include, but are not limited to, buses (e.g., a data bus), interconnects, traces, and planes. In one or more implementations, the host 102 and the accelerator device 104 are disposed on a single physical entity (e.g., a single computer chip houses both the host 102 and the accelerator device 104). Additionally or alternatively, the host 102 and the accelerator device 104 are disposed on separate physical entities (e.g., a first computer chip houses the host 102, while a second computer chip houses the accelerator device 104). Although depicted as including one accelerator device 104, it is to be appreciated that any number of accelerator devices 104 are includable in the system 100 without departing from the spirit or scope of the described techniques.

The host 102 is an electronic circuit that reads, translates, and executes tasks of a program 106. Examples of the host 102 include, but are not limited to, a central processing unit (CPU), a field-programmable gate array (FGPA), and an application-specific integrated circuit (ASIC). As shown, the host 102 includes a compiler 108, which represents computer software that runs on the host 102 to translate (e.g., compile) the program 106 from a high-level source programming language into machine code, byte code, or some other low-level programming language that is executable by hardware components of the system 100.

The accelerator device 104 is an electronic circuit that is designed to execute a particular type of task of the program 106 with increased efficiency, as compared to the host 102. Examples of the accelerator device 104 include, but are not limited to, a graphics processing unit (GPU), a digital signal processor (DSP), a vision processing unit (VPU), and a cryptographic accelerator. In a specific but non-limiting example, the host 102 is a central processing unit (CPU) configured to perform general purpose processing tasks, and the accelerator device 104 is a graphics processing unit (GPU) configured to perform graphics processing tasks. Broadly, the host 102 offloads tasks to the accelerator device 104 to be executed by a processing element array 110, which includes a plurality of processing elements that are each capable of processing individual tasks of the program 106 in parallel.

In accordance with the described techniques, the host 102 receives the program 106 as a task graph 112, which includes nodes that are processing kernels (e.g., referred to herein as “tasks”) and edges that indicate dependencies between individual processing kernels of the task graph 112. In general, the system 100 is configured to schedule tasks of the task graph 112 in a way that preserves the dependencies, while maximizing in-parallel execution of the tasks by the processing element array 110.

Conventional techniques implement scheduling logic in the host 102 to statically schedule the tasks. More specifically, the host 102 schedules tasks to a task queue 114 of the accelerator device 104, and inserts barriers between individual tasks to enforce dependencies. The barriers, for example, instruct the accelerator device 104 to stall dispatching tasks from the task queue 114 to the processing element array 110 until a task finishes executing and resolves a dependency. However, in various scenarios, the barriers prevent a subsequent task that is deeper in the task queue 114 from being dispatched, despite the subsequent task having no dependencies or having all dependencies resolved. This is referred to as “head-of-line blocking” in the task queue 114, and leads to decreased in-parallel execution of the tasks since tasks which are ready to be executed are prevented from doing so.

In addition to the head-of-line blocking inefficiencies introduced by the barriers, static scheduling of the task graph 112 is a nondeterministic polynomial complete (NP-complete) problem. Due to the complexity of the static scheduling problem, significant computational resources are utilized to statically schedule the tasks. Notably, task graphs 112 having finer task granularity include an increased number of tasks and an increased number of dependencies between tasks, as compared to task graphs 112 having coarser task granularity. While finer task granularity for the task graph 112 enables increased parallelism for executing the tasks (e.g., based on there being more tasks that are executable simultaneously), finer task granularity also increases task scheduling overhead (e.g., based on there being more dependencies that scheduling logic tracks and preserves).

To alleviate the head-of-line blocking inefficiencies and task scheduling overhead, techniques are described herein for aggregation and scheduling of accelerator executable tasks. As shown, the accelerator device 104 includes a command processor 116, which in at least one example, is a central processing unit (CPU) embedded in a same computer chip that houses the accelerator device 104. The command processor 116 includes a scheduler 118 configured to schedule tasks that have resolved dependencies for execution by the processing element array 110. In one or more examples, the scheduler 118 is implemented as firmware on the command processor 116.

In accordance with the described techniques, the host 102 receives the task graph 112, and the compiler 108 partitions the task graph 112 into a plurality of fibers 120. Each respective fiber 120 includes multiple tasks as well as dependencies between the multiple tasks (e.g., task level dependencies). In one or more implementations, the fibers 120 are represented in a fiber graph that includes dependencies between the fibers 120 (e.g., fiber level dependencies). In addition to generating the fibers 120, the compiler 108 also defines operations 122 for each of the fibers 120. In one or more implementations, the compiler 108 defines the operations in an intermediate representation. One example intermediate representation framework is low level virtual machine (LLVM) multi-level intermediate representation (MLIR). However, the operations 122 are definable by the compiler 108 in any suitable intermediate representation framework without departing from the spirit or scope of the described techniques.

Broadly, the operations 122 of a fiber 120 instruct the scheduler 118 to move the fiber 120 between a sleep pool 124 and a ready pool 126 based on whether the tasks within the fiber 120 have unresolved dependencies. More specifically, the operations 122 instruct the scheduler 118 to place the fiber 120 in the sleep pool 124 if all unexecuted tasks within the fiber 120 have an unresolved dependency. In addition, the operations 122 instruct the scheduler 118 to place the fiber 120 in the ready pool 126 if at least one task within the fiber 120 does not have any unresolved dependencies. In other words, a fiber 120 is placed in the ready pool 126 if at least one task in the fiber 120 is independent (e.g., does not have any dependencies) or the dependencies of at least one task in the fiber 120 have been resolved. Notably, a dependent task has an “unresolved dependency” when the task on which the dependent task depends has not yet been executed by the processing element array 110. Further, a dependent task has a “resolved dependency” when the task on which the dependent task depends has been executed by the processing element array 110.

Once generated by the compiler 108, the host 102 communicates the fibers 120 and corresponding operations 122 to the command processor 116. Although defined in the intermediate representation, the operations 122 are received by the command processor 116 and the scheduler 118 in a different representation that is interpretable by the command processor 116 and/or the scheduler 118. In various examples, the operations 122 are converted to one or more packet-based commands (e.g., heterogeneous system architecture (HSA) packets), converted to byte code, and/or the fibers 120 include metadata describing the operations 122. Regardless, the scheduler 118 interprets the operations 122, and moves the fibers 120 between the sleep pool 124 and the ready pool 126 in accordance with the operations 122.

In one or more implementations, the command processor 116 moves independent tasks and/or tasks having resolved dependencies from the ready pool 126 to the task queue 114. However, the command processor 116 does not move tasks from fibers 120 that are in the sleep pool 124 to the task queue 114. As used herein, the command processor 116 is considered to have “launched” a task when the command processor 116 places the task in the task queue 114. The command processor 116 is further configured to dispatch tasks from the task queue 114 to the processing element array 110 for execution. Upon a task being executed, the processing element array 110 communicates a completion signal 128 to the scheduler 118 indicating that execution of the task has completed. In this way, the scheduler 118 is notified when a dependent task that depends on an executed task has a resolved dependency, and as such, a fiber 120 that includes the dependent task is ready to be placed in the ready pool 126. In variations, the completion signals 128 are implemented using atomic memory operations (AMO) in accordance with the HSA standard. Additionally or alternatively, the accelerator device 104 includes a hardware signaling mechanism configured to transmit the completion signals 128 to the command processor 116 and/or scheduler 118.

Consider an example in which a fiber 120 includes an independent task T1, a dependent task T2, and a dependency indicating that T2 is dependent on T1. In this example, the operations 122 instruct the command processor 116 to launch T1, and place the fiber 120 in the sleep pool 124 because T2's dependency on T1 is unresolved. Furthermore, the command processor 116 dispatches T1 from the task queue 114 to the processing element array 110 for execution. Upon completing execution of T1, the processing element array 110 communicates a completion signal 128 to the scheduler 118 indicating that T1 has been executed. In response, the operations 122 instruct the scheduler 118 to place the fiber 120 in the ready pool 126 based on T2's dependency on T1 being resolved. The command processor 116 then launches T2 to be executed by the processing element array 110.

Since the command processor 116 solely launches independent tasks and/or tasks having resolved dependencies from the ready pool 126, the task queue 114 solely includes tasks that are ready to be dispatched. Thus, in contrast to conventional techniques, the described techniques enable tasks in the task queue 114 to be dispatched without stalling. Further, in one or more implementations, the scheduler 118 concurrently moves multiple independent fibers between the sleep pool 124 and the ready pool 126. Thus, the described techniques enable the command processor 116 to launch tasks from fibers 120 that are in the ready pool 126, while one or more fibers 120 in the sleep pool 124 are waiting for dependencies to be resolved. This contrasts with conventional techniques which stall dispatching tasks while waiting for a dependency to be resolved. Accordingly, the described techniques enable more tasks to be in-flight simultaneously, thereby increasing in-parallel execution of tasks by the processing element array 110 and improving overall computer performance.

Moreover, the system 100 utilizes a hybrid scheduling technique in which both dynamic scheduling and static scheduling are utilized to schedule the tasks. Indeed, the individual tasks within each fiber 120 are statically scheduled by the compiler 108 (e.g., by defining the operations 122). This contrasts with conventional techniques that statically schedule the tasks using host-based scheduling logic. Due to the complexity of the static scheduling problem, simplifications and heuristics are often used to solve the static scheduling problem, which introduces inaccurately scheduled tasks. The compiler 108 has increased task graph processing capabilities as compared to host-based scheduling logic. Therefore, by utilizing the compiler 108 for task scheduling, the described techniques statically schedule the tasks with increased accuracy, which also improves overall computer performance.

In accordance with the hybrid scheduling technique, the fibers 120 are dynamically scheduled by the scheduler 118 while the program 106 is being executed. For example, the command processor 116 stalls launching tasks from a dependent fiber 120 until the tasks within an additional fiber 120 on which the dependent fiber 120 depends have been executed by the processing element array 110. In other words, the command processor 116 activates the dependent fiber 120 (e.g., by beginning to launch tasks from the dependent fiber 120 while the scheduler 118 moves the dependent fiber 120 between the sleep pool 124 and the ready pool 126) in response to the tasks within the additional fiber 120 being executed. By partitioning the task graph 112 into the fibers 120, the compiler 108 coarsens the task graph 112, thereby creating fewer schedulable entities for the scheduler 118 to schedule. Indeed, conventional host-based scheduling logic schedules each individual task to the task queue 114 of the accelerator device 104, whereas the command processor-based scheduler 118 solely schedules the fibers 120. Therefore, the described techniques decrease scheduler overhead and enable efficient execution of finer-grained task graphs, thereby increasing in-parallel execution of the tasks and improving overall computer performance.

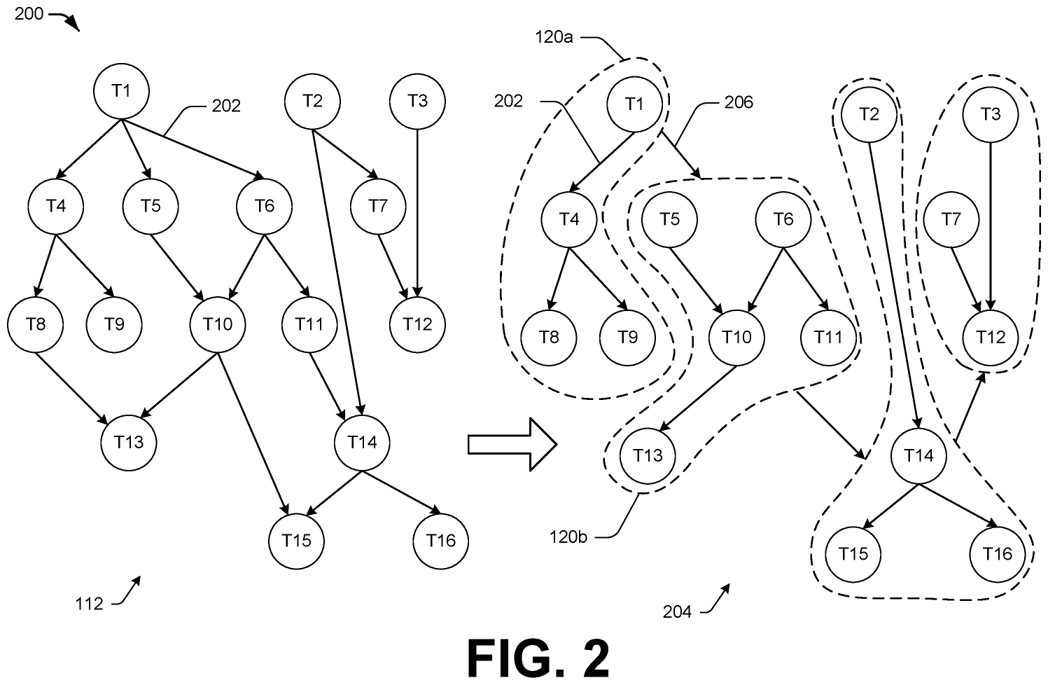

FIG. 2 depicts a non-limiting example 200 in which a compiler 108 partitions a task graph 112 into fibers 120. As shown, the example 200 includes a task graph 112 that includes a plurality of tasks (e.g., T1, T2, T3, . . . , T16), and task level dependencies 202 between the tasks (e.g., shown as arrows between individual tasks). For example, an arrow pointing from a first task to a second task indicates that the second task is dependent on the first task. In one or more implementations, the task graph 112 is a directed acyclic graph, meaning that any path through the task graph 112 (e.g., following the depicted arrows) does not form a closed loop.

As shown, the compiler 108 generates a fiber graph 204 from the task graph 112. The fiber graph 204 includes multiple fibers 120 (e.g., shown as dashed lines encompassing groups of tasks) that each represent a different portion of the task graph 112. In addition, the fiber graph 204 includes fiber level dependencies 206 (e.g., shown as arrows between the fibers 120). By way of example, an arrow pointing from a first fiber 120 to a second fiber 120 indicates that at least one task within the second fiber 120 depends on at least one task within the first fiber 120. The compiler 108 is configured to construct the fiber graph 204 in a manner that preserves the acyclic nature of the task graph 112. In other words, the compiler 108 generates the fiber graph 204 in a way that there are no fibers 120 that are both dependent on and a dependency to another fiber 120.

In one or more implementations, the compiler 108 utilizes a depth first aggregation (DFA) policy to group the tasks. In accordance with this strategy, the compiler 108 aggregates tasks into a respective fiber 120 by traversing deeper layers of the task graph 112 before traversing a same layer of the task graph 112. The illustrated example 200 depicts a fiber 120a aggregated in accordance with the DFA policy. As shown, the compiler 108 aggregates T1, T4, and T8 into the fiber 120a. In accordance with the DFA strategy, the compiler 108 further analyzes T13 to be aggregated to the fiber 120a, but determines that doing so results in a cycle. For example, aggregating T13 results in the fiber 120a being dependent on an additional fiber 120b (e.g., based on T13's dependence on T10) and a dependency to the additional fiber 120b (e.g., based on T5's dependence on T1).

In a conservative approach for avoiding cycles, the compiler 108 avoids adding the task that results in a cycle (e.g., T13) for the fiber 120a. Instead, the compiler 108 analyzes tasks at a deepest layer of the task graph 112 for which a task has already been aggregated into the fiber 120a. If the compiler 108 determines that all dependencies of a non-aggregated task at the deepest layer are already included in the fiber 120a, then the compiler 108 aggregates the task into the fiber 120a. As shown in the illustrated example 200, for instance, the compiler 108 aggregates T9 into the fiber 120a. This is because (1) T9 is disposed at a deepest layer for which a task has already been aggregated into the fiber 120a (e.g., the layer that includes T8), and (2) T9 is dependent on T4, which has already been aggregated into the fiber 120a.

In a greedy approach for avoiding cycles (not depicted), the compiler 108 analyzes tasks that are dependencies to the task (e.g., T13) that results in a cycle for the fiber 120a. In accordance with the greedy approach, if tasks that are dependencies to T13 are capable of being added to the fiber 120a to eliminate the cycle created by T13, then the compiler 108 aggregates the tasks to the fiber 120a. By way of example, the compiler 108 determines that, by adding T10 and T5 (e.g., dependencies to T13) to the fiber 120a, the cycle created by T13 is eliminated. Therefore, in this example, the compiler 108 adds T10 and T5 to the fiber 120a.

Additionally or alternatively, the compiler 108 utilizes a breadth first aggregation (BFA) policy to group the tasks. In accordance with this policy, the compiler 108 aggregates tasks into a respective fiber 120 by traversing all tasks at a certain layer of the task graph 112 before moving on to a deeper layer of the task graph 112 until a threshold number of tasks have been aggregated. Consider an example in which the compiler 108 utilizes a breadth first aggregation policy to aggregate the depicted task graph 112 in accordance with a threshold fiber size of four tasks. In this example, the compiler 108 aggregates T1, T2, T3, and T4 into a first fiber, T5, T6, T7, and T8 into a second fiber, and so on. Notably, the BFA policy naturally avoids cycles.

Notably, the BFA policy creates fibers having fewer fiber level dependencies 206 than the BFA policy. In other words, a fiber 120 generated in accordance with the BFA policy has fewer outgoing edges (e.g., to other fibers 120) than a fiber 120 generated in accordance with the DFA policy. In one or more implementations, inter-fiber communication is more computationally expensive than intra-fiber communication. Therefore, BFA task aggregation benefits from decreased communication overhead, as compared to the DFA policy. However, the DFA policy creates fibers 120 having more task level dependencies 202 than the BFA policy. Therefore, the DFA policy benefits from increased task locality, in comparison to the BFA policy.

Since both the BFA policy and the DFA policy provide different advantages, a hybrid policy is implementable in various scenarios. In one example hybrid policy, the compiler 108 initially aggregates the tasks using the DFA policy, and switches to the BFA policy in response to determining that a number of outgoing edges from a current fiber 120 exceeds a threshold. In another example hybrid policy, the compiler 108 initially aggregates the tasks using the BFA policy, and switches to the DFA policy in response to traversing a predetermined number of layers of the task graph 112. It is to be appreciated that any known graph partitioning technique is implementable by the compiler 108 to partition the task graph 112 without departing from the spirit or scope of the described techniques, examples of which include edge-cut and vertex-cut graph partitioning techniques.

In one or more implementations, the fiber graph 204 includes multiple independent fibers 120 (e.g., multiple fibers 120 which do not depend on one another). In accordance with these implementations, the command processor 116 is configured to activate the multiple independent fibers 120 simultaneously. While simultaneously activated, the scheduler 118 simultaneously moves the multiple independent fibers 120 between the sleep pool 124 and the ready pool 126, and the command processor 116 simultaneously launches tasks from the multiple independent fibers 120. In various scenarios, therefore, the command processor 116 dispatches at least one task from each of the multiple independent fibers 120 for in parallel execution by the processing element array 110.

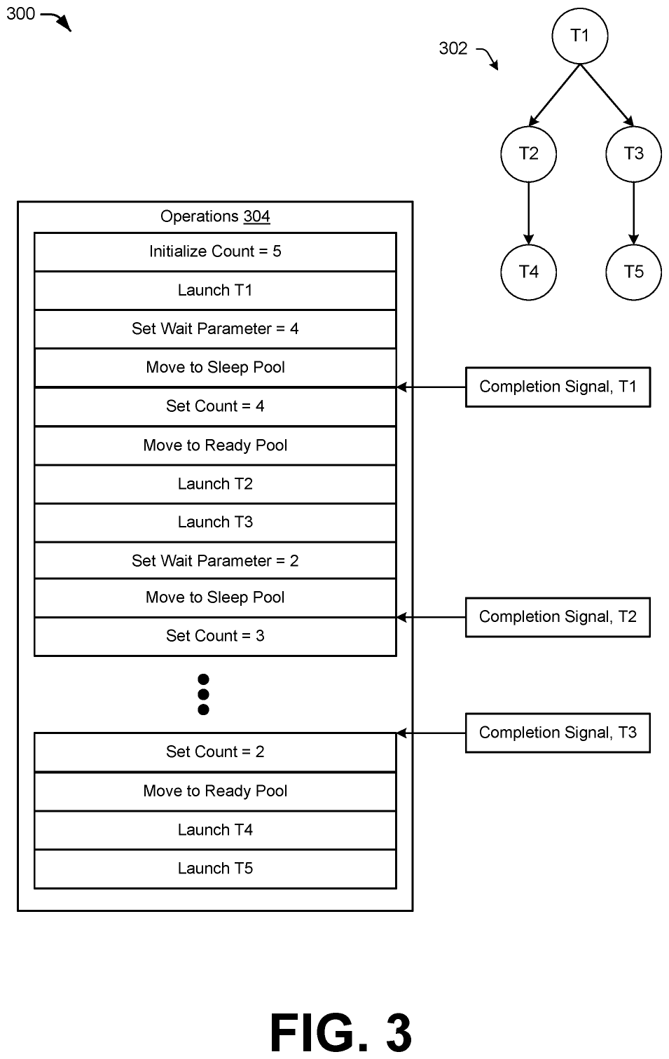

FIG. 3 depicts a non-limiting example 300 having a fiber 302 and a set of operations 304 for launching tasks within the fiber 302. Generally, the operations 304 establish a count which tracks a number of remaining unexecuted tasks in the fiber 302, and the count is reduced in response to a completion signal 128 being received by the scheduler 118. Further, the operations 304 establish a wait parameter indicating a value of the count that represents a resolved dependency. When the count is unequal (e.g., greater than) the wait parameter, the next task in the fiber 302 to be launched is dependent on at least one additional task in the fiber 302 that has been launched, but has not yet been executed by the processing element array 110. This indicates an unresolved dependency. Accordingly, the scheduler 118 moves the fiber to the sleep pool 124 while the count is unequal to the wait parameter. Further, when the count is subsequently reduced to be equal to the wait parameter, the next task to be launched in the fiber 302 has a resolved dependency based on the additional task on which the next task depends having been executed by the processing element array 110. Accordingly, the scheduler 118 places the fiber 302 in the ready pool 126 while the count is equal to the wait parameter.

Here, the count is initially set to a value of five because there are five tasks in the fiber 302. Since T1 is independent of the other tasks in the fiber, the command processor 116 launches T1. After T1 is launched, the wait parameter is set to a value of four because, once T1 finishes executing and reduces the count, the dependencies of T2 and T3 are resolved, and as such, T2 and T3 are ready for launch. Further, while the count is unequal to the wait parameter, the scheduler 118 moves the fiber 302 to the sleep pool 124. Then, the scheduler 118 receives a completion signal 128 indicating that T1 has finished executing, and as such, the scheduler 118 sets the count to a value of four. Since the count is now equal to the wait parameter, the scheduler 118 moves the fiber 302 to the ready pool 126. Furthermore, the command processor 116 sequentially launches both T2 and T3 without stalling since both T2 and T3 do not have any unresolved dependencies.

In this example 300, the operations 304 are defined to reduce the count in order of task execution, regardless of which task was launched first (e.g., an execution order count reduction policy). Therefore, in scenarios in which multiple independent tasks are in-flight simultaneously, it is possible for the count to be reduced based on a completion signal 128 for a subsequently launched task despite a previously launched task being unexecuted. In the example 300, for instance, T2 is launched before T3. However, it is possible for the completion signal 128 of T3 to be received by the scheduler 118 before the completion signal 128 for T2. Given this, the scheduler 118 is configured to delay launching T4 and T5 until the completion signals 128 for both T2 and T3 are received. Accordingly, the wait parameter is conservatively set to a value of two after T2 and T3 are launched, and the fiber 302 is moved to the sleep pool 124 because the count (e.g., four) is greater than the wait parameter (e.g., two).

As shown, the scheduler 118 receives the completion signal for T2 and reduces the count to a value of three. Since the count (e.g., three) is still greater than the wait parameter (e.g., two), the fiber 302 remains in the sleep pool 124. Subsequently, the scheduler 118 receives the completion signal for T3, and reduces the count to a value of two. Since the count is now equal to the wait parameter, the scheduler 118 moves the fiber 302 to the ready pool 126, and the command processor 116 sequentially launches T4 and T5 without stalling. Notably, after the completion signal for T2 is received, T4 is ready to be launched. However, T4 is delayed from launch because the compiler 108 conservatively sets the wait parameter to a value of two based on the count being reduced in order of task execution. This inefficiency is alleviated by reducing the count in order of task launch, as further discussed below.

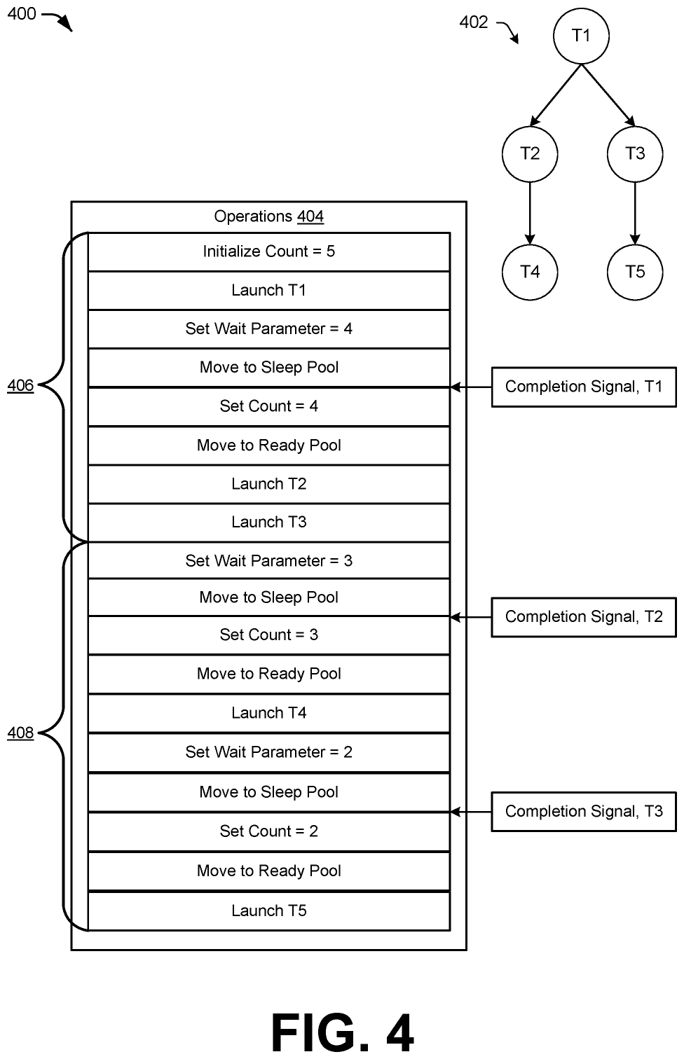

FIG. 4 depicts a non-limiting example 400 having a fiber 402 and a set of operations 404 for launching tasks within the fiber 402. In particular, the operations 404 are defined to reduce the count in order of task launch, regardless of which task executes first (e.g., launch order count reduction policy). Here, a first subset of operations 406 are identical to the operations 304, and as such, the first subset of operations 406 are discussed above with reference to FIG. 3. Accordingly, the following discussion focuses on a second subset of operations 408 that differ from the operations 304.

In accordance with the launch order count reduction policy, the scheduler 118 is configured to stall reduction of the count based on a completion signal 128 for a subsequently launched task until an additional completion signal 128 is received for a previously launched task. Therefore, in scenarios in which multiple independent tasks are in-flight simultaneously, the count is guaranteed to be reduced based on a completion signal for a previously launched task first. In the example 400, for instance, T2 is launched before T3. Thus, in a situation in which T3 is executed before T2, the scheduler 118 stalls reducing the count until a completion signal 128 for T2 is received. Given this, after T2 and T3 are launched, the compiler 108 sets the wait parameter to a value of three because the count is guaranteed to be reduced based on T2's completion signal 128 first. This contrasts with the execution order task reduction policy discussed above, which conservatively sets the wait parameter to a value of two after T2 and T3 are launched. Further, the scheduler 118 moves the fiber 402 to the sleep pool 124 because the count is greater than the wait parameter.

As shown, the scheduler 118 receives the completion signal 128 for T2 and reduces the count to a value of three. Since the count is now equal to the wait parameter, the scheduler 118 moves the fiber 402 to the ready pool 126. Further, the command processor 116 launches T4, and in response, the scheduler 118 sets the wait parameter to a value of two. Since the count is now greater than the wait parameter, the scheduler moves the fiber 402 to the sleep pool 124. After receiving the completion signal for T3, the scheduler 118 reduces the count to a value of two. Since the count is now equal to the wait parameter, the scheduler 118 moves the fiber 402 to the ready pool 126 and the command processor 116 launches T5. In contrast to the execution order count reduction policy, T4 is launched without delay after the completion signal for T2 is received. However, even when the launch order count reduction policy is implemented, launch delay is still possible. In an example scenario in which T3 finishes executing before T2, the command processor 116 delays launching T5 despite T5's dependency on T3 being resolved. This inefficiency is alleviated by dividing the fiber into sub-fibers and independently processing the sub-fibers, as further discussed below.

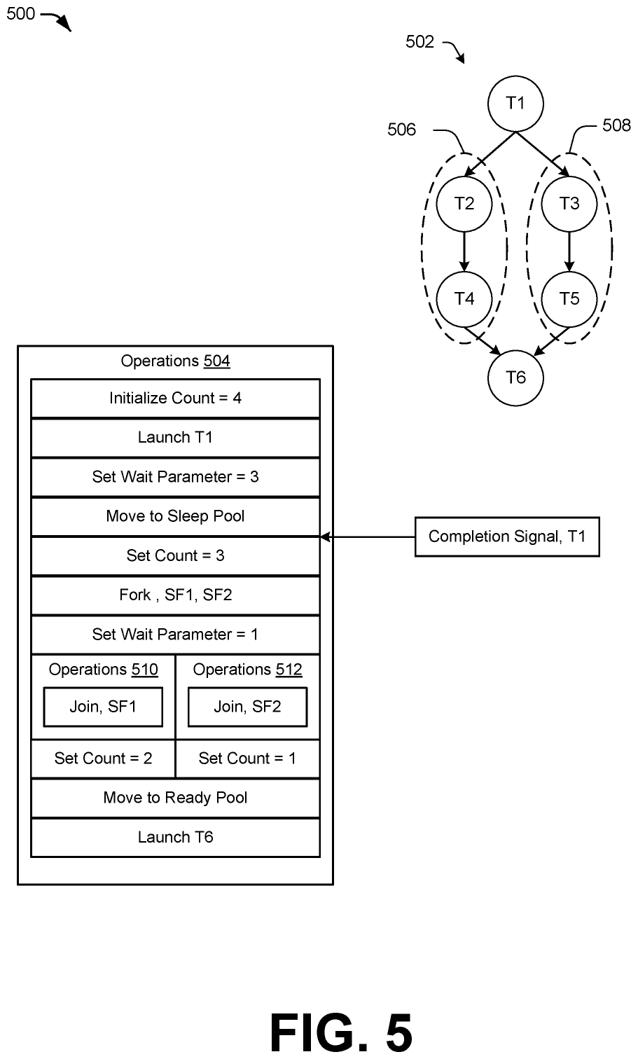

FIG. 5 depicts a non-limiting example 500 having a fiber 502 and a set of operations 504 for launching tasks within the fiber 502. Broadly, the operations 504 are defined to generate multiple sub-fibers 506, 508 from a parent fiber 502 and independently process the multiple sub-fibers 506, 508 in parallel.

In one or more implementations, the sub-fibers 506, 508 are each treated as one entity for purposes of the count. Given this, the operations 504 initially set the count for the parent fiber 502 to a value of four because the parent fiber 502 includes two tasks and two sub-fibers 506, 508. Since T1 is independent of the other tasks in the parent fiber 502, the command processor 116 launches T1. After T1 is launched, the wait parameter for the parent fiber 502 is set to a value of three and the scheduler 118 moves the parent fiber 502 to the sleep pool 124. After receiving a completion signal 128 for T1, the scheduler 118 sets the count to a value of three.

Rather than moving the parent fiber 502 to the ready pool 126, however, the compiler 108 defines a fork operation to create the sub-fibers 506, 508 from the parent fiber 502. In one or more implementations, the compiler 108 divides the parent fiber 502 into the sub-fibers 506, 508 based on each of the sub-fibers including two or more tasks that are independent of tasks within the other sub-fiber. Here, for example, the compiler 108 defines a fork operation to generate the sub-fibers 506, 508 because the tasks in a first sub-fiber 506 (e.g., T2 and T4) are independent of the tasks in a second sub-fiber 508 (T3 and T5). Further, the wait parameter for the parent fiber 502 is set to a value of one because, once the first sub-fiber 506 and the second sub-fiber 508 finish executing and reduce the count, T6's dependencies on the sub-fibers 506, 508 are resolved. Meanwhile, the parent fiber 502 remains in the sleep pool 124.

In accordance with the described techniques, the compiler 108 defines a set of operations 510 for scheduling the tasks in the first sub-fiber 506. Further, the compiler 108 defines a set of operations 512 for scheduling the tasks in the second sub-fiber 508. The sub-fibers 506, 508 are treated as separate independent fibers by the compiler 108 for purposes of defining the operations 510, 512. In other words, the operations 510, 512 for the sub-fibers 506, 508 instruct the scheduler 118 to independently move the sub-fibers 506, 508 between the sleep pool 124 and the ready pool 126 based on separate counts maintained for the different sub-fibers 506, 508.

By way of example, the operations 510 for the first sub-fiber 506 initialize the count at two because there are two tasks in the first sub-fiber 506. Since T2 is independent of the other tasks in the first sub-fiber 506, the command processor 116 launches T2. After T2 is launched, the wait parameter for the first sub-fiber 506 is set to a value of one, and the scheduler 118 places the first sub-fiber 506 in the sleep pool 124 based on the count and the wait parameter being unequal. In response to receiving a completion signal 128 for T2, the scheduler 118 reduces the count for the sub-fiber 506 to a value of one. Since the count is now equal to the wait parameter, the scheduler 118 moves the first sub-fiber 506 to the ready pool 126, and the command processor 116 launches T4. Similar operations 512 are defined for the second sub-fiber 508.

In one or more implementations, the compiler 108 defines a join operation for a sub-fiber, which reduces the count of the parent fiber 502 in response to each of the tasks within a sub-fiber having been executed. Here, for example, the operations 510 for the first sub-fiber 506 include a join operation to reduce the count of the parent fiber 502 in response to the scheduler 118 receiving a completion signal 128 for T4. Accordingly, the count for the parent fiber 502 is reduced to a value of two based on the join operation for the first sub-fiber 506. Similarly, the operations 512 for the second sub-fiber 508 include a join operation to reduce the count of the parent fiber 502 in response to the scheduler 118 receiving a completion signal for T5. Thus, the count for the parent fiber 502 is reduced to a value of one based on the join operation for the second sub-fiber 508. Given that the count for the parent fiber 502 is equal to the wait parameter, the scheduler 118 moves the parent fiber 502 to the ready pool 126 and the command processor 116 launches T6. Although execution of the first sub-fiber 506 is depicted and described as completing before the second sub-fiber 508 in the example 500, this is not to be construed as limiting. Instead, the sub-fibers 506, 508 are independently executable, and as such, the sub-fibers 506, 508 are capable of being executed in any order.

By dividing the fiber 502 into independent sub-fibers 506, 508, the described techniques enable the operations 510, 512 of the independent sub-fibers 506, 508 to be processed concurrently. In other words, the scheduler 118 simultaneously moves the sub-fibers 506, 508 between the sleep pool 124 and the ready pool 126, and the command processor 116 simultaneously launches tasks from the sub-fibers 506, 508. In various scenarios, therefore, the command processor 116 dispatches at least one task from each of the sub-fibers 506, 508 for in parallel execution by the processing element array 110. Moreover, the sub-fiber generation and independent processing techniques discussed above reduce launch delay in comparison to the execution order count reduction policy and the launch order count reduction policy. Indeed, regardless of whether T2 or T3 finishes executing first, T4 is launched without delay after the completion signal 128 for T2 is received. Similarly, T5 is launched without delay after the completion signal 128 for T5 is received.

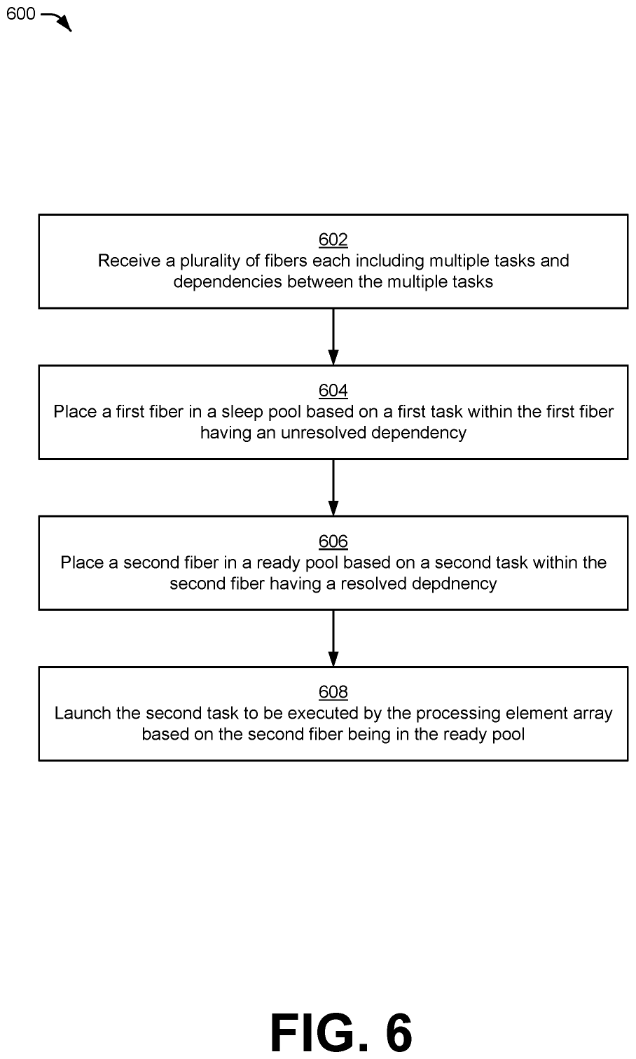

FIG. 6 depicts a procedure 600 in an example implementation of aggregation and scheduling of accelerator executable tasks. A plurality of fibers are received that each include multiple tasks and dependencies between the multiple tasks (block 602). By way of example, the compiler 108 receives the task graph 112 and partitions the task graph into fibers 120 that each include multiple tasks and dependencies between the multiple tasks. Further, the host 102 communicates the fibers 120 to the command processor 116.

A first fiber is placed in a sleep pool based on a first task within the first fiber having an unresolved dependency (block 604). For example, the compiler 108 defines operations 122 for a first fiber 120 that instruct the scheduler 118 to place the first fiber 120 in the sleep pool 124 based on a first task within the first fiber 120 having an unresolved dependency. In at least one example, the first task is dependent on an additional task in the first fiber 120. In this example, the unresolved dependency is based on the additional task having been launched by the command processor 116, but not having been executed by the processing element array 110.

A second fiber is placed in a ready pool based on a second task within the second fiber having a resolved dependency (block 606). For example, the compiler 108 defines operations 122 for a second fiber 120 that instruct the scheduler 118 to place the second fiber 120 in the ready pool 126 based on a second task within the second fiber having a resolved dependency. In an example, the second task is dependent on an additional task in the second fiber 120. In this example, the resolved dependency is based on the additional task having been launched by the command processor 116, and subsequently executed by the processing element array 110.

The second task is launched to be executed by the processing element array based on the second fiber being in the ready pool (block 608). For example, the command processor 116 moves the second task from the second fiber 120 to the task queue 114 (i.e., the command processor 116 launches the second task) based on the second fiber 120 being in the ready pool 126. Furthermore, the command processor 116 dispatches the second task from the task queue 114 to the processing element array 110 for execution. The command processor 116, however, does not launch tasks from the first fiber 120 based on the first fiber 120 being in the sleep pool 124.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host 102, the accelerator device 104, the compiler 108, the processing element array 110, the command processor 116, and the scheduler 118) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. An accelerator device, comprising:
a processing element array; and
a command processor to:
receive a plurality of fibers each including multiple tasks and dependencies between the multiple tasks;
place a first fiber in a sleep pool based on a first task within the first fiber having an unresolved dependency;
place a second fiber in a ready pool based on a second task within the second fiber having a resolved dependency; and
launch the second task to be executed by the processing element array based on the second fiber being in the ready pool.

2. The accelerator device of claim 1, wherein the first task is dependent on an additional task within the first fiber, and the unresolved dependency is based on the additional task having been launched by the command processor but unexecuted by the processing element array.

3. The accelerator device of claim 1, wherein the second task is dependent on an additional task within the second fiber, and the resolved dependency is based on the additional task having been launched by the command processor and subsequently executed by the processing element array.

4. The accelerator device of claim 3, wherein the command processor is configured to:
maintain a count of remaining unexecuted tasks in the second fiber;
set a wait parameter indicating a value of the count that represents the resolved dependency;
receive a completion signal from the processing element array indicating that the additional task has been executed;
reduce the count in response to the completion signal being received; and
place the second fiber in the ready pool based on the reduced count being equal to the value indicated by the wait parameter.

5. The accelerator device of claim 4, wherein the command processor is configured to reduce the count in order of task execution, the count being reduced based on the completion signal despite a previously launched command of the second fiber being unexecuted.

6. The accelerator device of claim 4, wherein the command processor is configured to reduce the count in order of task launch, the command processor stalling reduction of the count based on the completion signal until an additional completion signal is received indicating that a previously launched command of the second fiber has been executed.

7. The accelerator device of claim 1, wherein the plurality of fibers indicate fiber level dependencies between the plurality of fibers, and wherein the command processor is configured to stall launch of tasks from a dependent fiber until the multiple tasks of an additional fiber on which the dependent fiber depends are executed by the processing element array.

8. The accelerator device of claim 1, wherein the plurality of fibers include multiple independent fibers, and wherein the command processor is configured to dispatch at least one task from each of the multiple independent fibers for in parallel execution by the processing element array.

9. A computing device, comprising:
an accelerator device that includes a command processor and a processing element array; and
a host that includes a compiler, the compiler configured to:
receive a task graph that includes a plurality of tasks and indicates dependencies between the plurality of tasks;
generate a fiber graph by partitioning the task graph into multiple fibers, the multiple fibers including, respectively, multiple tasks of a different portion of the task graph; and
define operations for the multiple fibers, the operations instructing the command processor to move the multiple fibers from a sleep pool to a ready pool based on the dependencies of the multiple fibers being resolved, tasks from fibers that are in the ready pool being launched by the command processor to be executed by the processing element array.

10. The computing device of claim 9, wherein the operations are defined by the compiler in an intermediate representation.

11. The computing device of claim 9, wherein a respective fiber includes a first task and a second task that is dependent on the first task, and the operations for the respective fiber instruct the command processor to launch the first task to be executed by the processing element array, place the respective fiber in the sleep pool based on the first task being launched, and move the respective fiber to the ready pool based on the first task having been executed by the processing element array.

12. The computing device of claim 9, wherein the fiber graph indicates fiber level dependencies between the multiple fibers, the fiber level dependencies directing the command processor to stall launch of tasks from a dependent fiber until the multiple tasks of an additional fiber on which the dependent fiber depends are executed by the processing element array.

13. The computing device of claim 9, wherein the fiber graph indicates multiple independent fibers, the multiple independent fibers directing the command processor to dispatch at least one task from each of the multiple independent fibers for in parallel execution by the processing element array.

14. The computing device of claim 9, wherein the task graph is a directed acyclic graph, and the multiple fibers are acyclic.

15. A method, comprising:
receiving, by a command processor of an accelerator device, a fiber that includes multiple tasks and dependencies between the multiple tasks;
generating, by the command processor, multiple sub-fibers from the fiber, the multiple sub-fibers each including two or more tasks that are independent of tasks within other sub-fibers;
placing, by the command processor, a first sub-fiber in a sleep pool based on a first task within the first sub-fiber having an unresolved dependency;
placing, by the command processor, a second sub-fiber in a ready pool based on a second task within the second sub-fiber having a resolved dependency; and
launching, by the command processor, the second task to be executed by a processing element array of the accelerator device based on the second sub-fiber being in the ready pool.

16. The method of claim 15, further comprising:
moving, by the command processor, the first sub-fiber to the ready pool based on the unresolved dependency being resolved; and
launching, by the command processor, the first task to be executed by the processing element array in parallel with the second task.

17. The method of claim 15, wherein the first task is dependent on an additional task within the first sub-fiber, and the unresolved dependency is based on the additional task having been launched by the command processor but unexecuted by the processing element array.

18. The method of claim 15, wherein the second task is dependent on an additional task within the second sub-fiber, and the resolved dependency is based on the additional task having been launched by the command processor and subsequently executed by the processing element array.

19. The method of claim 15, further comprising:
maintaining, by the command processor, a count of remaining unexecuted tasks in the first sub-fiber;
setting, by the command processor, a wait parameter indicating a value of the count that represents the unresolved dependency being resolved; and
placing, by the command processor, the first sub-fiber in the sleep pool based on the count being unequal to the value.

20. The method of claim 15, further comprising:
maintaining, by the command processor, a count of remaining unexecuted tasks in the second sub-fiber;
setting, by the command processor, a wait parameter indicating a value of the count that represents the resolved dependency; and
placing, by the command processor, the second sub-fiber in the ready pool based on the count being equal to the value.
